(19) United States
(12) Patent Application Publication
(10) Pub. No.: US 2025/0328568 A1
(43) Pub. Date: Oct. 23, 2025

(54) Content-Based Feedback Recommendation Systems and Methods

(71) Applicant: Google LLC, Mountain View, CA (US)

(72) Inventors: Vikram Aggarwal, Palo Alto, CA (US); Ajay Jayant Joshi, San Carlos, CA (US); Xiang Li, Alameda, CA (US); Ofer Pinhas Meshi, San Jose, CA (US)

(21) Appl. No.: 19/253,358

(22) Filed: Jun. 27, 2025

Related U.S. Application Data
(60) Provisional application No. 63/665,839, filed on Jun. 28, 2024.

(51) Int. Cl. G06F 16/338

(52) U.S. Cl. CPC G06F 16/338

(57) ABSTRACT

Aspects of the disclosed technology include computer-implemented systems and methods for conversational recommendation systems, such as conversational chatbots that are configured to process user queries and generate responses. A recommendation system can receive a user query, provide a recommendation response, and solicit feedback from a user in a target domain. The system can display a first set of items and receive inputs indicative of preferences relative to the first set of items. The system can generate preference embeddings in an embedding space of the target domain based at least in part on the preferences and compare the preference embeddings with item embeddings in the embedding space. The system can select content items based at least in part on a distance between the preference embeddings and the item embeddings in the target embedding space and generate data for displaying the selected content items via the user interface.

### PRIORITY CLAIM

The present application claims priority to U.S. Patent Application No. 63/665,839, entitled “Content-Based Feedback Recommendation Systems and Methods,” having a filing date of Jun. 28, 2024, which is incorporated by reference herein.

### FIELD

The present disclosure relates generally to machine learning processes and machine-learned devices and systems. More particularly, the present disclosure relates to machine-learned models for conversational recommendation systems.

### BACKGROUND

Artificial intelligence systems increasingly include large foundational machine-learned (ML) models which have the capability to provide a wide range of new product experiences. As an example, machine-learned sequence processing models such as large language modes (LLMs) have proven successful at many computing tasks such as providing artificial intelligence (AI) chatbot interactions that include chat-style interfaces and communications. An LLM-based chatbot can receive user queries and provide responses in a conversational manner using natural language. A chat may culminate in an actionable question and/or command. Today's ML-based chatbots, however, provide limited assistance in determining many factors relative to recommendations to fulfill a user's intent from a user query. As such, the systems tend to be inefficient as users often provide many queries to systems in order to finally receive a response that fulfills their intent. Due to the large memory and processing capacity required to deploy ML-based systems at scale, these inefficiencies can lead to underperformance of the chatbot and large consumptions of computing resources.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a computing system that includes one or more computing devices. The method includes receiving, via a user interface displaying a first set of items, one or more inputs indicative of one or more preferences relative to one or more of the first set of items, generating, using one or more machine-learned embedding models, one or more preference embeddings in an embedding space for a target content domain based at least in part on the one or more preferences, comparing the one or more preference embeddings with a plurality of item embeddings in the embedding space, selecting a second set of content items based at least in part the one or more preference embeddings and the plurality of item embeddings in the embedding space, and generating data for displaying the second set of content items via the user interface.

Another example aspect of the present disclosure is directed to a computing system that includes one or more processors and one or more computer-readable storage media that collectively store instructions that, when executed by one or more processors, cause the one or more processors to perform operations. The operations include receiving, via a user interface displaying a first set of items, one or more inputs indicative of one or more preferences relative to one or more of the first set of items, generating, using one or more machine-learned embedding models, one or more preference embeddings in an embedding space for a target content domain based at least in part on the one or more preferences, comparing the one or more preference embeddings with a plurality of item embeddings in the embedding space, selecting a second set of content items based at least in part on the one or more preference embeddings and the plurality of item embeddings in the embedding space, and generating data for displaying the second set of content items via the user interface.

Another example aspect of the present disclosure is directed to one or more non-transitory computer-readable storage media that store instructions that, when executed by one or more processors, cause the one or more processors to perform operations. The operations include receiving, via a user interface displaying a first set of items, one or more inputs indicative of one or more preferences relative to one or more of the first set of items, generating, using one or more machine-learned embedding models, one or more preference embeddings in an embedding space for a target content domain based at least in part on the one or more preferences, comparing the one or more preference embeddings with a plurality of item embeddings in the embedding space, selecting a second set of content items based at least in part on the one or more preference embeddings and the plurality of item embeddings in the embedding space, and generating data for displaying the second set of content items via the user interface.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a conversational recommendation system according to example embodiments of the present disclosure;

FIG. 2 is a block diagram depicting an example computing environment including conversational recommendation according to example embodiments of the present disclosure;

FIG. 3 is a block diagram depicting an example computing environment including a conversational recommendation user interface according to example embodiments of the present disclosure;

FIG. 4 is a block diagram depicting an example computing environment 400 including a conversational recommendation system according to an example embodiment of the present disclosure.

FIG. 5 is a flowchart diagram depicting an example method of generating a recommendation response using a conversational recommendation system according to example embodiments of the present disclosure;

FIG. 6 is a flowchart diagram depicting an example method of selecting items for receiving user feedback in a target content domain according to example embodiments of the present disclosure;

FIG. 7 is a flowchart diagram illustrating an example method for training a machine-learned model according to example implementations of aspects of the present disclosure;

FIG. 8 is a block diagram of an example processing flow for using machine-learned model(s) to process input(s) to generate output(s) according to example embodiments of the present disclosure;

FIG. 9 is a block diagram of an example sequence processing model according to example embodiments of the present disclosure;

FIG. 10 is a block diagram of an example technique for populating an example input sequence for processing by a sequence processing model according to example embodiments of the present disclosure;

FIG. 11 is a block diagram of an example model development platform according to example embodiments of the present disclosure;

FIG. 12 is a block diagram of an example training workflow for training a machine-learned model according to example embodiments of the present disclosure;

FIG. 13 is a block diagram of an inference system for operating one or more machine-learned model(s) to perform inference according to example embodiments of the present disclosure;

FIG. 14 is a block diagram of an example networked computing system according to example embodiments of the present disclosure;

FIG. 15 is a block diagram of an example computing device according to example embodiments of the present disclosure; and

FIG. 16 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and methods for conversational recommendation systems, such as conversational chatbots that are configured to process user queries and generate responses using natural language. A conversational recommendation system is provided that includes a recommendation engine and machine-learning system including one or more machine-learned models such as large-language models, multi-modal language models, text-to-image models, etc. The recommendation system can include a conversational recommendation model such as a large language model or other sequence processing model that is configured to provide a conversational user interface for receiving user queries and generating responses. More particularly, the conversational recommendation system can include a feedback system that is configured to embed preference information in an embedding space for a target content domain based on user feedback and determine recommended items based on the proximity or similarity between item embeddings and preference embeddings in the target domain. By way of example, the system can display items and receive user feedback such as preferences for the displayed items. The system can embed positive and negative preferences in an embedding space for a target domain, such as a visual domain or a music domain. Item embeddings in the embedding space that are closer to the positive preference embeddings and further from the negative preference embeddings can be selected for a recommendation response. In this manner, the system can provide recommendations based on the particular content of items, such as the appearance of an item or the tempo of music.

Traditional search-based systems are configured to provide authoritative-based responses with objective notions of correctness, etc. On the other hand, recommendation systems are often confronted with subjective notions of “goodness.” Recommendation systems may be configured to provide responses that are based on user attributes, preferences, and notions of satisfaction. Recommendation systems often attempt to determine notions of satisfaction based on feedback from users, however, it is difficult for feedback systems to determine the basis for a user's positive or negative feedback. For example, a user may or may not like the look, price, or brand of a product or may or may not like the style, instrumentation, or tempo of a piece of music. Determining a particular attribute that is liked or disliked can be difficult.

Traditional conversational recommendation systems, such as those deployed for online shopping chatbots and the like, provide limited assistance in determining a recommendation's suitability for a particular user. These systems do not provide an intuitive or versatile way to refine shopping queries beyond pre-implemented filters that are often specific to the source of a product or service. In many instances, these systems require users to conduct research or possess prior knowledge in order to find the right recommendation. In traditional recommendation systems that employ large language models, recommendations are provided without full consideration of information to solicit from a user and information to provide to a user. While these systems sometimes utilize user feedback, it is often difficult to ascertain what aspects of a particular recommendation were or were not acceptable to a user. For instance, if a user indicates a positive preference for a clothing item, these systems are unable to determine if the positive or negative preference was for the appearance of the item (e.g., color, cut, texture, etc.), the price of the item, or the brand of the item, etc. Similarly, if a user indicates a positive preference for a piece of music or video, these systems are unable to determine if the positive or negative preference was for the sound of the music (e.g., tempo, instrumentation, etc.) or the artist, etc. The poor responses provided by these systems can lead to user's reformulating and submitting many different queries in an effort to receive a satisfactory response. Large amounts of power and computing capacity can be used by these systems in order to process multiple queries before providing a suitable response.

According to example embodiments of the present disclosure, a conversational recommendation system is provided that includes a feedback system that is configured to determine user preference information in a target content domain. For example, user preferences for a set of items such as example clothing items can be embedded into a target visual domain using one or more machine-learned embedding models. A corpus of available items can also be embedded into the target visual domain. The user preference embeddings in the target visual domain can be compared with item embeddings in the target visual domain. Recommended items can be selected based on their distance from the preference embeddings in the target domain. In this manner, the recommendation system can obtain feedback and provide recommendations based on the isolated content of items alone.

In accordance with example embodiments of the present disclosure, a conversational recommendation system can be configured to display items in a feedback user interface and receive feedback from a user with respect to the items. For example, the user interface can include user interface elements for a user to indicate a positive (e.g., thumbs up) or negative (e.g., thumbs down) preference for items. The system can generate preference embeddings in an embedding space for a target content domain based on the user preferences. For example, a shopping recommendation system may embed user preferences in an embedding space for a visual domain. A music recommendation system may embed user preference in an embedding space for an audio domain. The system can then compare the user preference embeddings to the item embeddings in the embedding space. The system can select a set of recommended items based on the distance between the user preference embeddings and the item embeddings. The system can then generate display data for displaying the set of recommended items to the user via the user interface.

According to example aspects of the present disclosure, the system can be configured to receive user queries for recommendations, such as for recommendations of physical items such as clothing, automobiles, etc. or digital items such as music or movies. The system can provide the query as an input to a conversational recommendation model such as a large language model. The conversational recommendation model can generate one or more responses such as item retrieval queries for retrieving items based on the user query. The retrieval queries can be provided to a search system to retrieve one or more items responsive to the retrieval queries. The system can display at least a portion of the items in a recommendation interface. The system can select a set of the items for display in the feedback interface to solicit user feedback.

In example embodiments, the system can select a set of content items for user feedback using a preference elicitation system. The preference elicitation system can be configured to determine which items should be shown to a user to get their feedback. The system can attempt to elicit information from the user that cannot be understood from other data. The system can select items that best enable a user to navigate an item space. By way of example, if a user is shopping for jackets, the system may choose a selection of leather, polyester, and fleece jackets. These allow the user to observe options and provide feedback based on the content of the items (e.g., visual look). Various approaches can be used by the preference elicitation system. In an example, the preference elicitation system promotes items that are similar to other items. The preference elicitation system can promote items from the user's history, from the user preferences, or from a current recommendation set. The system can score items based on their similarity to other items, using a cosine function for example. The preference elicitation system can try to maximum coverage over the embedding space in an example. The system can promote items that are closer or more similar to points in the embedding space and that are not already covered by previously shown items. In other examples, the preference elicitation system can use a bayesian posterior update.

According to example implementations, the conversation recommendation system can include a preference application system that is configured to determine a set of recommended items based on user preferences. The system can determine a similarity between a current set of recommended items, sometimes referred to as a slate of items, and the user preferences. The system can determine a similarity between embeddings of the current set of recommended items and the user preference embeddings in the embedding space of the target domain. The system can select items that are closer to the positive preference embeddings and further from the negative preference embeddings. The system can discard items that are within a threshold distance of a negative preference embedding and increase the ranking of items that are closer to the positive preference embeddings. By way of example, if a user provides positive preferences for long-sleeved and leather items and negative preferences for short-sleeve and fleece items, the system can increase the ranking of long-sleeved leather items, while maintaining parameters such as a gender, price, and brand.

According to an example aspect of the present disclosure, a conversational recommendation system can be implemented as or as part of a chatbot-based product or service recommendation, such as an online chatbot that facilitates conversational-based shopping. A chat-style interface can provide an immersive experience for user interactions for obtaining information via a web platform. The systems and methods may be utilized to determine search results (e.g., product or service recommendations) that are responsive to an intent of a multi-turn chat session.

In the retrieval stage, the model can access external computing services to determine information relative to the user query, and/or the model can access one or more memories to retrieve information relative to the user query, such as previously stored user data. The conversational recommendation model can provide one or more recommendations that are tailored to the user at one or more conversational turns.

According to example aspects of the present disclosure, a conversational recommendation system can include a conversation data store or other memory configured to facilitate arbitrarily long conversations using the conversational recommendation model. The conversation data store can include a database or other storage system configured to store data such as factual information, statements, or other information that the model may need to access during the conversation in order to fulfill the user's intent.

According to example aspects of the present disclosure, a conversational recommendation system can be configured to interact with one or more external computing services such as search engines, shopping engines, video hosting services, etc. These services can be local computing services such as first-party computing services or remote computing services such as third-party computing services. A conversational recommendation model can be trained to generate computer-executable code (e.g., code snippets) to interact with the external computing services. For example, the recommendation model can generate code to retrieve product reviews from a website or to retrieve different products available at a particular price point, etc.

In accordance with example embodiments of the present disclosure, a conversational recommendation system can include a prompt generator that is configured to generate one or more prompts for input to the recommendation model based on a user query. By way of example, an input prompt can include a model preamble, a conversation history, and a current user query. The model preamble can include contextual information such as a listing of external computing services available to the model, memory available to the model, instructions for the model to reason at each conversation turn, etc.

According to example embodiments of the disclosed technology, a server computing system, such as a cloud computing system, can host or otherwise implement a conversational recommendation system that is available to one or more user computing devices over one or more computer networks. The conversational recommendation system can provide a user interface that facilitates a natural language interface with one or more machine-learned recommendation models. The conversational recommendation system can implement a chatbot such as a shopping chatbot, travel chatbot, code editing chatbot, or other conversational agent that is configured to receive user queries and generate recommendation responses. A recommendation response can include a product recommendation, service recommendation, music or video recommendation, or any other recommendation.

Systems and methods in accordance with example embodiments of the present disclosure provide a number of technical effects and benefits. In particular, the systems and methods can include a computing system that implements a conversational recommendation system having a feedback system that is configured to solicit user feedback about items based on content in a target content domain. User preferences and a corpus of items can be embedded in an embedding space for the target domain. The system can select recommendation results based on the distance between user preference embeddings and item embeddings in the embedding space. In this manner, user preferences in particular target domains can be isolated and used to provide improved recommendations.

As an example technical effect and benefit, the systems and methods in accordance with the disclosed technology can reduce power consumption and compute relative to traditional recommendation systems. Embodiments of the disclosed technology can more accurately determine user intent from a user query and generate recommendation results to reduce the overall number of queries that are processed. The systems and methods in accordance with the disclosed technology facilitate model reasoning and recommendations so as to solicit and provide information to more accurately fulfill a user's intent. In this manner, the system can generate a response that fulfills a user intent using a reduced number of inputs to the machine-learned model. As a result, the processing, memory, and power consumption associated with the conversational recommendation system can be reduced.

In example implementations, a conversational recommendation model can include a sequence processing model such as a large language model (LLM). Much of the following disclosure refers to large language models as specific examples of sequence processing models but it will be appreciated that the disclosure is equally applicable to any type of sequence processing model. For example, the disclosed technology can be used with large image models, multimodal models, and other types of foundational models. For instance, the sequence processing models can operate in domains other than the text domain, such as image domains, audio domains, biochemical domains, etc. A sequence processing model may be referred to as a generative model. The sequence processing model may be trained to respond to input data and provide a generative output such as a text prediction based on an image input and a text input. Alternatively and/or additionally, the generative model can include an image generation model (e.g., a text-to-image diffusion model). In some implementations, the generative model can process multimodal data to generate output data, which can include image data, text data, content data, audio data, and/or latent encoding data.

With reference now to the Figures, example embodiments of the present disclosure will be discussed in further detail.

### Example System and Model Arrangements

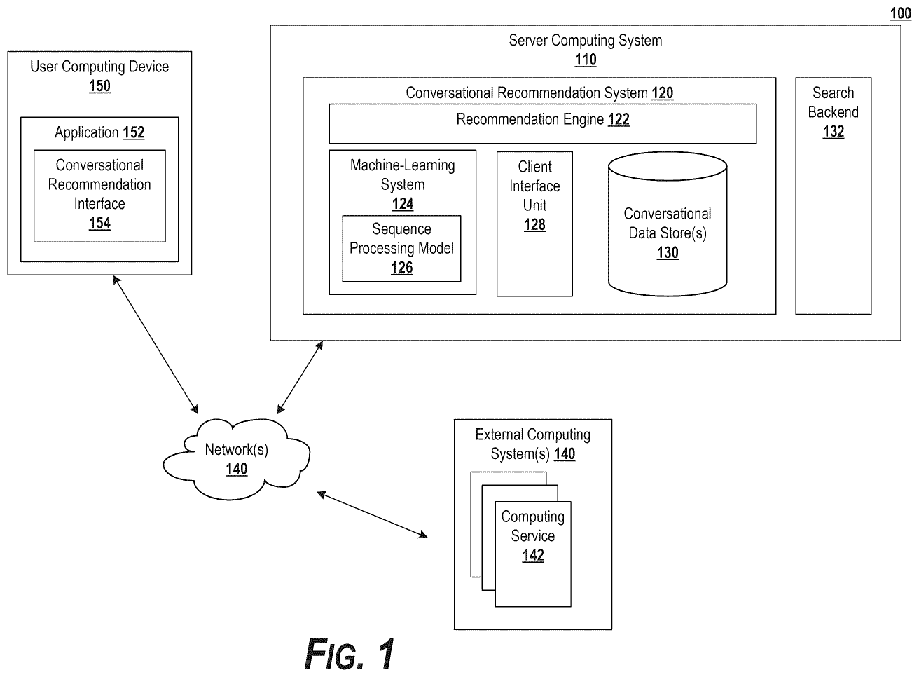

FIG. 1 is a block diagram depicting an example computing environment 100 including a server computing system 110 that hosts or otherwise implements a conversational recommendation system 120 that can be accessed by user computing devices such as user computing device 150 executing an application 152. Computing environment 100 includes one or more external computing systems 140 that host or otherwise implement one or more computing services 142 accessible to server computing system 110 and/or user computing device 150. Although a single user computing device is shown, any number of user computing devices may access the server computing system 110.

In some examples, server computing system 110 may be implemented by a first computing system, external computing system 140 can be implement by another computing system, and each user computing device 150 can be implemented by a different remote computing system. For instance, computing environment 100 may be implemented as a client server computing environment, including one or more client computing devices implementing each of the user computing devices 150 and one or more server computing devices implementing server computing system 110 and external computing system(s) 140. In another example, one or more of the downstream applications can be implemented at a server computing system.

The computing systems implementing server computing system 110, user computing device 150, and external computing systems 140 can be connected by and communicate through one or more networks 180. Any number of user computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In example embodiments, a user computing device 150 implementing a downstream application 152 can be any suitable device, including, but not limited to, a smartphone, a tablet, a laptop, a desktop computer, or any other computer device that is configured such that it can allow a user to access remote computing devices over a network. The user computing devices can include one or more processor(s), memory, and a display as described in more detail hereinafter. The user computing devices can execute one or more client applications such as a web browser, email application, chat application, video conferencing application, word processing application or the like.

The server computing system 110 can include one or more processor(s) and memory implementing conversational recommendation system 120. The server computing system 110 can be in communication with the one or more user computing device(s) 150 using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Server computing system 110 can include or otherwise implement a conversational recommendation system 120 including a recommendation engine 122, machine-learning system 124, client interface unit 128, and conversational data store 130.

User computing device 150 can execute any number of applications. Application 152 can be any suitable application for accessing and displaying content from server computing system 110. For example, application 152 can be a web browser application or dedicated application that can render a conversational recommendation interface 154 using data received from conversational recommendation system 120, receive user input, and provide user input data to conversational recommendation system 120.

Client interface unit 128 can implement one or more application programming interfaces to receive data from and provide data to user computing devices 150, enabling users to access the conversational recommendation system using an application 152. In some examples, client interface unit 128 can generate data and/or computer-executable interface code to render conversational recommendation interface 154 at user computing device 150. The conversational recommendation interface 154 can include a user interface (UI) such as a graphical user interface (GUI) that can receive user queries and provide responses received from conversational recommendation system 120. The output of conversational recommendation model(s), such as text or executable code generated in response to a prompt, can be provided in the conversational recommendation interface 154. For example, the output of the recommendation model can be used to populate a text cell with text or other sequential data generated in response to the user query. In this manner, the outputs of the machine-learned model can be integrated into the conversational recommendation interface.

Server computing system 110 can implement a machine-learning system 124 including one or more sequence processing models 126. A sequence processing model 126 can include a machine-learned conversational recommendation model. Sequence processing model 126 can include any type of machine-learned sequence processing model. In an example, a sequence processing model can include a large language model (LLM) including 10B parameters or more. In another example, a sequence processing model can include a language model having less than 10B parameters (e.g., 1B parameters). In yet another example, the sequence processing model can include an autoregressive language model. Machine-learning system 124 may include additional machine learned models such as a machine-learned text-to-image model, a machine-learned text-to-video model, a machine-learned text-to-audio model, a machine-learned multi-modal model, or any other machine-learned model configured to provide generative content in response to a user query. The generative content generated by machine-learning system 124 can include text data, computer-executable code data, image data, video data, audio data, or other types of generative content. The conversational recommendation model can be trained to process input data to generate output data. The input data can include text data, image data, audio data, latent encoding data, and/or other input data, which may include multimodal data.

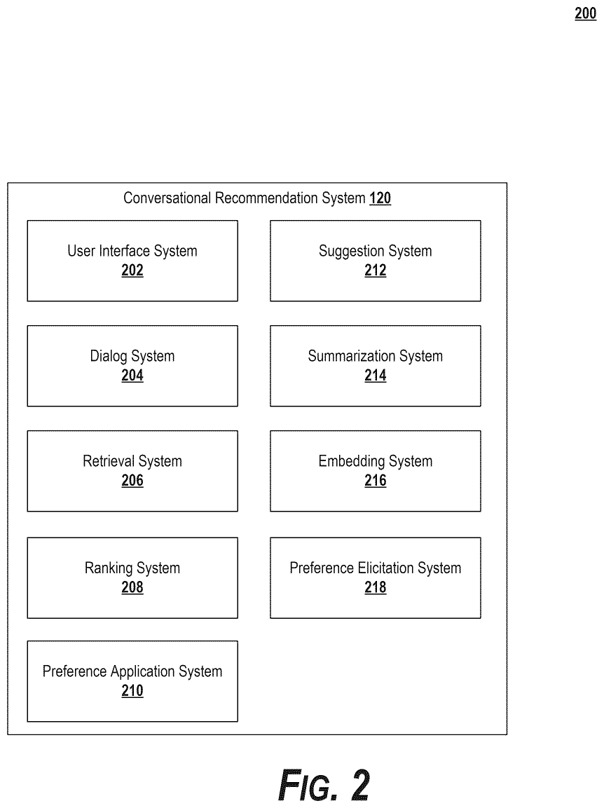

FIG. 2 is a block diagram depicting an example computing environment 200 including a conversational recommendation system 120 according to an example embodiment of the present disclosure. Conversational recommendation system 120 includes a user interface system 202, dialog system 204, retrieval system 206, ranking system 208, preference application system 210, suggestion system 212, summarization system 214, embedding system 216, and preference elicitation system 218.

User interface system 202 can be configured to receive data such as user queries from users and generate data such as recommendations or other responses to the user queries. Dialog system 204 can be configured to receive natural language or other inputs from a user and generate natural language or other outputs in response to the inputs. For example, dialog system 204 can receive a user query, submit the user query to a conversational recommendation model or other large language model and receive a set of item retrieval queries based on the user query. Dialog system 204 can include a query rewriter than can rewrite queries in example embodiments.

Retrieval system 206 is configured to retrieve items or results in response to a user query. For example, retrieval system 206 can issue to the set of retrieval queries from the dialog system to a search service (e.g., search backend 132), database, external computing service, or other system to retrieve items that are responsive to the retrieval queries.

Ranking system 208 is configured to obtain the search results from the retrieval system 206 and rank the results. Ranking system 208 can rank the search results based on one or more attributes and/or parameters. Ranking system 208 can include an attribute system, content embedding system, user embedding system in example embodiments. The attribute system can obtain or determine one or more attribute predictions associated with a user query. The content embedding system can obtain or determine one or more content embeddings associated with items. The user embedding system can obtain or determine one or more user embeddings associated with a user.

Preference application system 210 is configured to determine one or more recommended items from a set of recommendation results based on user preferences and/or other information. In some examples, preference application system 210 can be included as part of ranking system 208. Based on user preferences, the preference application system can compute a similarity between a current recommendation (e.g., from a slate of recommended items) and the user preferences. For example, the preference application system 210 can determine a similarity between items and preferences in an embedding space. The preference application system can be configured to select results that are closer to positive preferences and further from negative preferences. The preference application system can discard items that are within a threshold distance of a negative preference and increase the ranking of items that are within a threshold distance of a positive preference.

Suggestion system 212 can be configured to generate one or more item suggestions. Suggestion system 212 can include a user affinity system, item similarity system, recommendation similarity system, and a ranking or reranking system. The user affinity system can obtain or determine one or more user affinity attributes. The item similarity system can obtain or determine one or more similarities between items. The recommendation similarity system can obtain or determine one or more similarities between recommendations. The ranking system can rank a set of items for a feedback interface in example embodiments.

Summarization system 214 can be configured to generate one or more summarizations associated with a user query. Summarization system 214 can include a user summary system and a conversation summary system in example embodiments. The user summary system can generate one or more user summaries based on user data such as stored user attributes or determined user attributes from the conversation, for example. The conversation summary system can generate a summary of the current conversation.

Embedding system 216 can be configured to generate item embeddings and user preference embeddings in an embedding space for a target content domain. Embedding system 216 can include one or more machine-learned embedding models such as a text embedding model, image embedding model (e.g., visual encoder), audio embedding model or multi-modal embedding model. The embedding system 216 can operate offline to generate content embeddings for items such as items in a corpus of items that can be selected for a recommendation result.

Preference elicitation system 218 can be configured to select items to display to a user to solicit feedback. Preference elicitation system 218 can be configured to select items to obtain information about a user's preferences while balancing exploration of an available content space. In some embodiments, preference elicitation system 218 can be integrated with summarization system 214. In an example embodiment, the preference elicitation system can include a maximum coverage approach that seeks to maximize coverage of the embedding space. The system can promote items that are closer (e.g., more similar) to points in the embedding space that are not already covered by previously displayed items. In another example, the preference elicitation system can include a geometric approach that utilizes item embeddings. The geometric approach can promote items that are similar to other items, such as items from the user's history, items with previous positive feedback (items with negative preferences can similarly be demoted), and/or a current recommendation set. In some examples, the geometric approach can score each candidate item based on its similarity to other items, such as by using a cosine similarity function. For a set of reference items, the system can use a generalized mean to combine all similarities into one score.

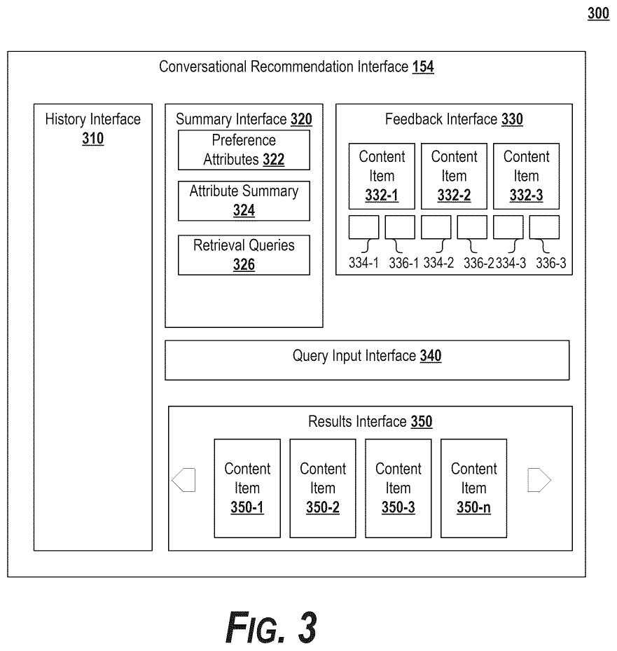

FIG. 3 is a block diagram depicting an example computing environment including an example conversational recommendation interface 154 in accordance with example embodiments of the present disclosure. Conversational recommendation interface 154 includes a query input interface 340 configured to receive user input queries and a results interface 350 configured to provide a slate of recommended items responsive to the user query. Results interface 350 displays a plurality of recommended items 350-1, 350-2, 350-3, . . . 350-n that are responsive to the user query. Any number of content items can be displayed. Results interface 350 includes user interface elements for receiving user input. The system can respond to the user input by “scrolling” or replacing one or more items displayed in the user interface with one or more other items from the slate of recommended items.

Conversational recommendation interface 154 includes a history interface 310 that can be configured to display previous user queries and text responses to the user queries. Interface 154 includes a summary interface 320 that is configured to provide summary information in association with a chat session. The summary interface 320 can display preference attributes 322 associated with the user, an attribute summary 324, and retrieval queries. The attribute summary 324 can be generated by a machine-learned sequence processing model based on the user query and/or conversation history.

Feedback interface 330 is configured to display a set of suggested items 332-1, 332-2, . . . 332-3 in association with a user query. Feedback interface 330 includes a separate panel that is configured to present options that the user can rate. For example, user interface elements 334 and 336 can be provided to indicate a positive preference or negative preference, respectively, for each suggested item. The feedback interface can be populated with items using the preference elicitation system. The preference elicitation system can select items that best enable the user to navigate the space of possible items. For example, a visual domain can be used so that the system can receive feedback that is indicative of the user's preference for the look of an item rather than other characteristics like price, brand, etc.

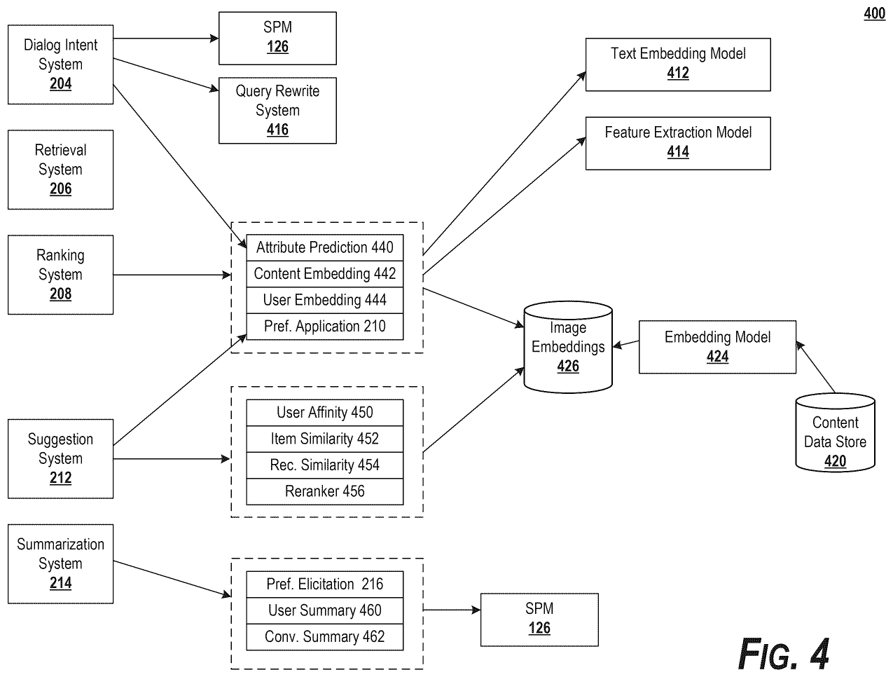

FIG. 4 is a block diagram depicting an example computing environment 400 including a conversational recommendation system according to an example embodiment of the present disclosure. FIG. 4 describes additional details of processing a user query to generate a slate of a recommendation results in an example implementation. Components of a conversational recommendation system including dialog system 204, retrieval system 206, ranking system 208, suggestion system 212, and summarization system 214 are depicted.

Dialog system 204 can receive a user query, via a conversational recommendation interface 134 for example, and determine one or more user intents associated with the user query. Dialog system 204 can issue one or more prompts based on the user query to a sequence processing model 126 such as a large language model or multimodal language model. Dialog system 204 can generate one or more prompts including instructions and/or examples for the sequence processing model to generate one or more item retrieval queries. Dialog system 204 can optionally call or otherwise use a query rewrite system 416 to rewrite one or more of the item retrieval queries.

A user query is one example of a possible input that can be received to determine a user intent. The user query can include any type of input data including text data, image data, audio data, video data, sensor data, latent encoding data, etc. In some examples, the user query can include a multimodal input including two or more types of input data, for example, a text input component and an image input component. The user query can indicate, include, or otherwise represent a target system action to be performed in response to the user query. The conversational recommendation system can process the user query to generate a recommendation response. A recommendation response is responsive to the user query and can include any type of output data including text data, image data, audio data, video data, sensor data, latent encoding data. A recommendation response can be provided to a user computing device which can render a conversational recommendation interface that includes the recommendation, such as a slate of items responsive to the query.

Retrieval system 206 can obtain and issue the item retrieval queries to a search service (e.g., search backend 132), database, external computing service 142, or other system or service to retrieve items that are responsive to the retrieval queries. Retrieval system 206 can receive a set of query results or items that are responsive to the one or more item retrieval queries.

Ranking system 208 can obtain the set of search results from retrieval system 206 and rank the results. Ranking system 208 can rank the search results based on one or more attributes and/or parameters. Ranking system 208 can include an attribute prediction system 440 that generates or obtains one or more attribute predictions associated with the user query. Ranking system 208 can include a content embedding system 442 that can obtain or determine one or more content embeddings associated with the set of items received from the retrieval system. Ranking system 208 can include a user embedding system 444 that can obtain or determine one or more user embeddings such as user preference embeddings associated with a user. Ranking system 208 can include a preference application system 210 that ranks the set of search items based on the attribute prediction(s), content embedding(s), and/or user embedding(s). For example, the preference application system 210 can rank the search results based on the distance between the image embeddings for each search result and the user preference embeddings in the embedding space.

An example of a target visual or image domain is depicted where image embeddings are stored in an image embeddings data store 426. Image embeddings for a set of available items in a content data store 420 can be generated using an embedding model such as a vision transformer (encoder). The user preference embeddings can be generated as one or more image embeddings and stored in the image embeddings data store.

After ranking the search results, the recommendation system can generate data to display the set of search results in the results interface 350 of the conversation recommendation interface 154.

Suggestion system 212 can include a user affinity system 450 that can obtain or determine one or more user affinity parameters, an item similarity system 452 that can obtain or determine one or more similarities between items, such as the set of search results, and a recommendation similarity system 454 that can obtain or determine one or more similarities between recommended items. Item similarity system 452 can determine a similarity between items in the set of search results based on their corresponding embeddings in the embedding space. For example, the item similarity system 452 can compare image embeddings of the items in the set of search results. Recommendation similarity system 454 can determine a similarity between previously recommended items based on their corresponding embeddings in the embedding space. Suggestion system 212 can include a reranker 456 than can rerank the set of search results for soliciting user feedback. For example, reranker 456 can access the preference elicitation data from the preference elicitation system 448 (discussed hereinafter), the user affinity data, the item similarity data, and the recommendation similarity data to determine a subset of the set of search results to display in the feedback interface 330 of the conversational recommendation interface.

Summarization system 214 can include a preference elicitation system 218 that is configured to determine a set of items for the feedback interface 330 that will enable maximum coverage of the target space. Additionally or alternatively, the preference elicitation system 218 can compare item embeddings to identify similar items to be displayed in the feedback interface 330. The system can identify similar items from the user's history, items for which feedback has been received, and/or a current recommendation set. Each candidate item can be scored based on its similarity to other items. Additionally or alternatively, the preference elicitation system 218 can use a bayesian posterior update to maintain a posterior distribution over user preferences. Given a prior distribution and optionally a pre-existing user history and/or session history, a distribution over preferences can be updated. Various criteria and/or approaches can be combined, for example using a weighted sum.

User summary system 460 can generate one or more user summaries and conversational summary system 462 can generate one or more conversation summaries. User summary system 460 and/or conversational summary system 462 can generate and provide one or more prompts to sequence processing model 126 to generate user summaries and/or conversational summaries.

### Example Methods

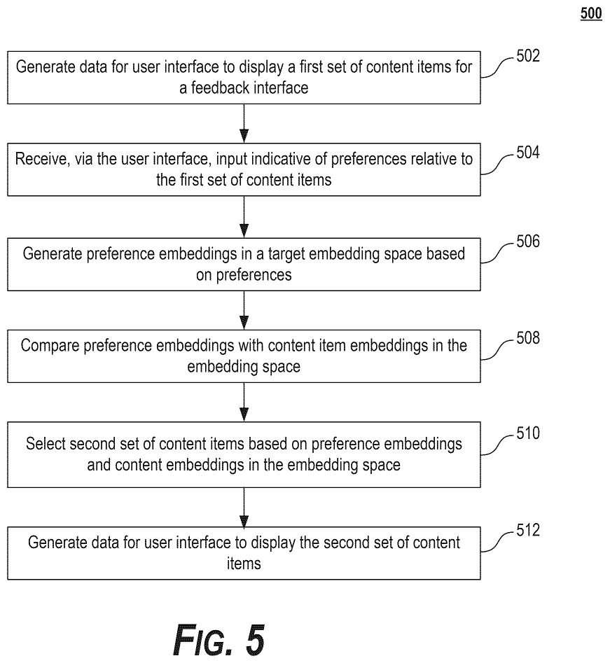

FIG. 5 is a flowchart diagram depicting an example method of generating a recommendation response using a conversational recommendation system according to example embodiments of the disclosed technology. For example, method 500 can be performed by a conversational recommendation system to solicit user feedback and provide item recommendations in a target content domain. One or more portion(s) of example method 500 and the other methods described herein can be implemented by a computing system that includes one or more computing devices. By way of example, one or more portions of example method 500 can be performed by a conversational recommendation system including one or more machine-learned models. Each respective portion of the example methods can be performed by any (or any combination) of one or more computing devices. Moreover, one or more portion(s) of the example method 500 can be implemented on the hardware components of the device(s) described herein, for example, to generate data for a user interface of a conversational recommendation system. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and are not meant to be limiting. One or more portions of the example methods can be performed additionally, or alternatively, by other systems.

At 502, method 500 can include generating data for a user interface to display a first set of items for a feedback interface of a conversational recommendation interface. In example embodiments, the first set of items can be determined by a preference elicitation system to solicit feedback from a user relative to a target domain.

At 504, method 500 can include receiving, via the feedback interface, one or more user inputs indicative of preferences relative to the first set of content items. For example, the user interface can include user interface elements for a user to indicate a positive (e.g., thumbs up) or negative (e.g., thumbs down) preference for items.

At 506, method 500 can include generating one or more preference embeddings in a target embedding space based on the preferences received from the user. For example, the user preferences can be embedded in an embedding space for an image domain in an example embodiment. The user preference embeddings can embed user preferences in a visual domain to represent the preferences visually based on the items for which the preferences were received.

At 508, method 500 can include comparing the user preference embeddings with one or more item embeddings in the target embedding space. The system can determine a similarity between item embeddings (e.g., a current set of recommended items) and the user preferences. The system can determine a similarity between embeddings of the set of recommended items and the user preference embeddings in the embedding space of the target domain.

At 510, method 500 can include selecting a second set of content items based on the user preference embeddings and the item embeddings in the embedding space. The system can select items based on a similarity or proximity between the preference embeddings. The system can select items based on the proximity or similarity between the user preference embeddings and the item embeddings in the embedding space. The system can select items that are closer to the positive preference embeddings and further from the negative preference embeddings based on distance in some examples.

At 512, method 500 can include generating data for a user interface to display the second set of content items. The slate of recommended items can be updated with the second set of content items in example embodiments.

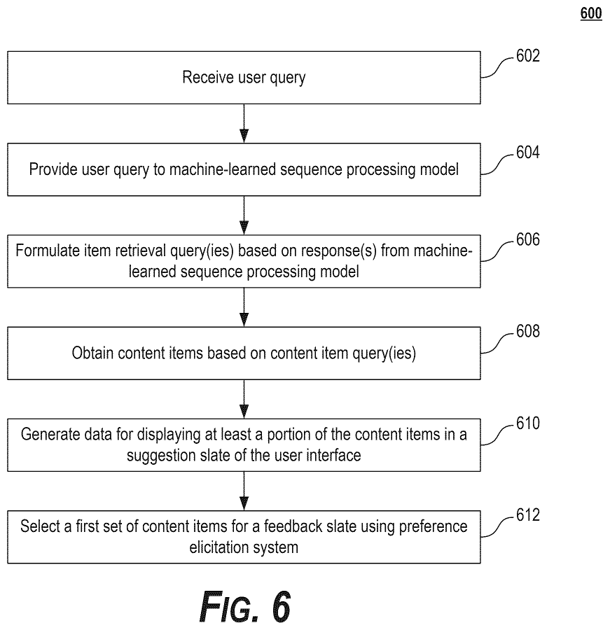

FIG. 6 is a flowchart diagram depicting an example method 600 of selecting items for receiving user feedback in a target content domain according to example embodiments of the disclosed technology. For example, method 600 can be performed by a conversational recommendation system to determine a set of items to display to a user to solicit user feedback and provide item recommendations in a target content domain.

At 602, method 600 can include receiving a user query. A user query is one example of a possible input that can be received to determine a user intent. The user query can include any type of input data including text data, image data, audio data, video data, sensor data, latent encoding data, etc. In some examples, the user query can include a multimodal input including two or more types of input data, for example, a text input component and an image input component. The user query can indicate, include, or otherwise represent a target system action to be performed in response to the user query.

At 604, method 600 can include providing the user query to a machine-learned sequence processing model and receiving one or more responses. For example, the user query can be provided to a conversational recommendation model that is configured to generate one or more responses such as item retrieval queries for retrieving items based on the user query.

At 606, method 600 can include formulating one or more item retrieval queries based on the response(s) from the sequence processing model. The item retrieval queries can be received as the responses from the sequence processing model in example embodiments. In some examples, the item retrieval queries can be formulated by rewriting item retrieval queries received from the sequence processing model.

At 608, method 600 can include obtaining content items based on the item retrieval query(ies). For example, the system can issue the item retrieval queries to a database, search engine, or other computer service/system to receive one or more items that are responsive to the item retrieval queries.

At 610, method 600 can include generating data for displaying at least a portion of the items in a results interface of the conversational recommendation interface.

At 612, method 600 can include selecting a first set of content items for a feedback interface of the conversational recommendation interface. In example embodiments, the system can select a set of content items for user feedback using a preference elicitation system. The preference elicitation system can be configured to determine which items should be shown to a user to get their feedback. The system can attempt to elicit information from the user that cannot be understood from other data. The system can select items that best enable a user to navigate an item space. By way of example, if a user is shopping for jackets, the system may choose a selection of leather, polyester, and fleece jackets. These allow the user to observe options and provide feedback based on the content of the items (e.g., visual look). Various approaches can be used by the preference elicitation system. In an example, the preference elicitation system promotes items that are similar to other items. The preference elicitation system can promote items from the user's history, from the user preferences, or from a current recommendation set. The system can score items based on their similarity to other items, using a cosine function for example. The preference elicitation system can try to maximum coverage over the embedding space in an example. The system can promote items that are closer or more similar to points in the embedding space and that are not already covered by previously shown items. In other examples, the preference elicitation system can use a bayesian posterior update.

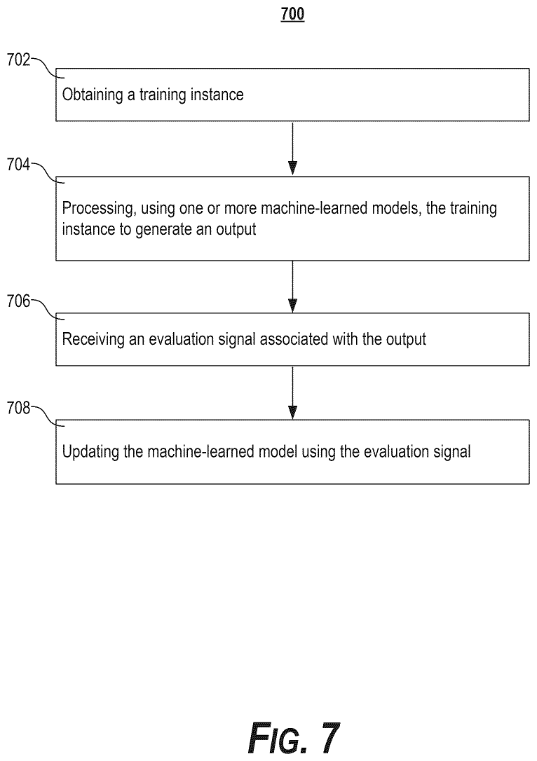

FIG. 7 depicts a flowchart of a method 700 for training one or more machine-learned models according to aspects of the present disclosure. For instance, an example machine-learned model can include a core sequence processing model, such as a foundational large language model (LLM).

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

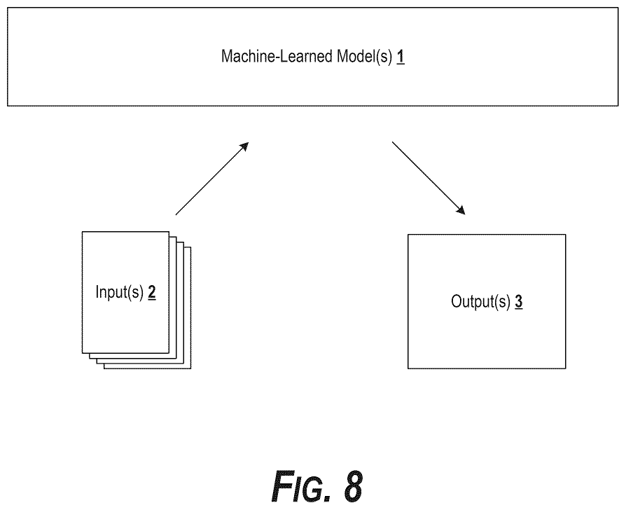

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

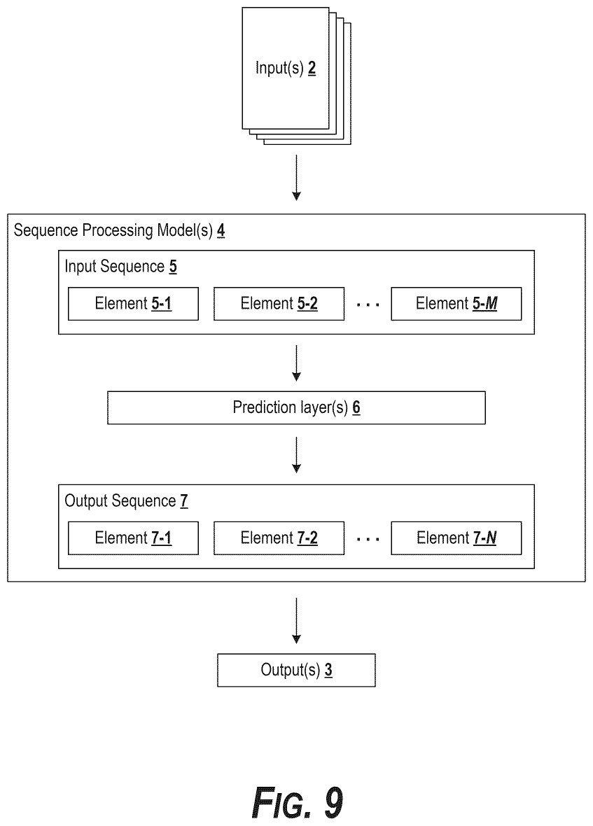

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ____.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

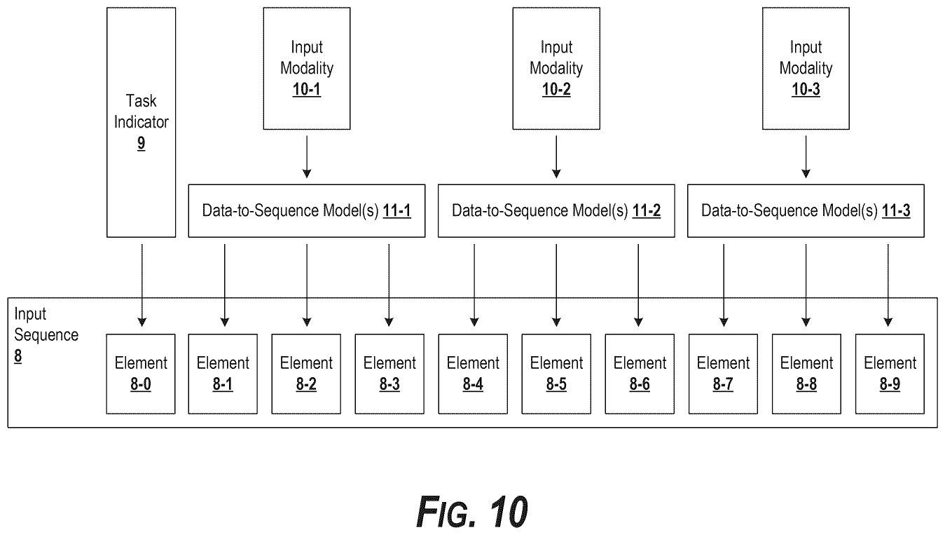

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

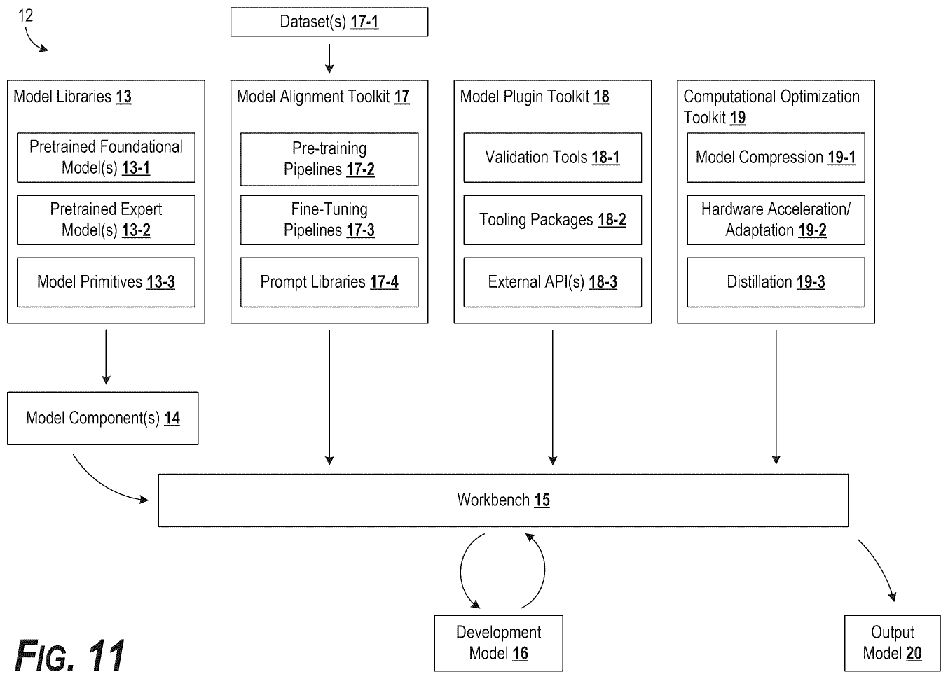

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

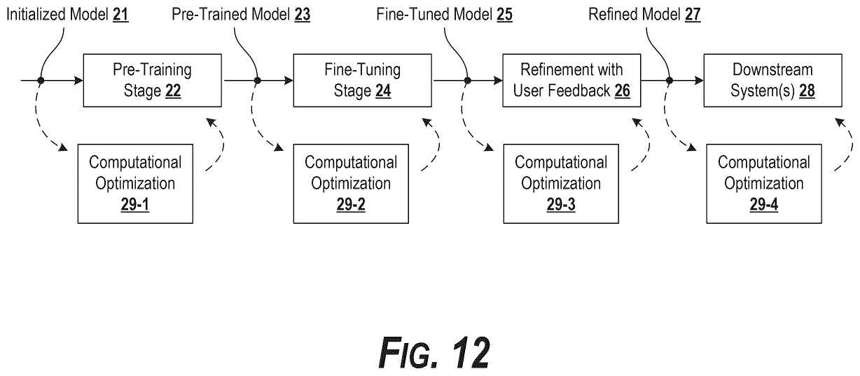

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

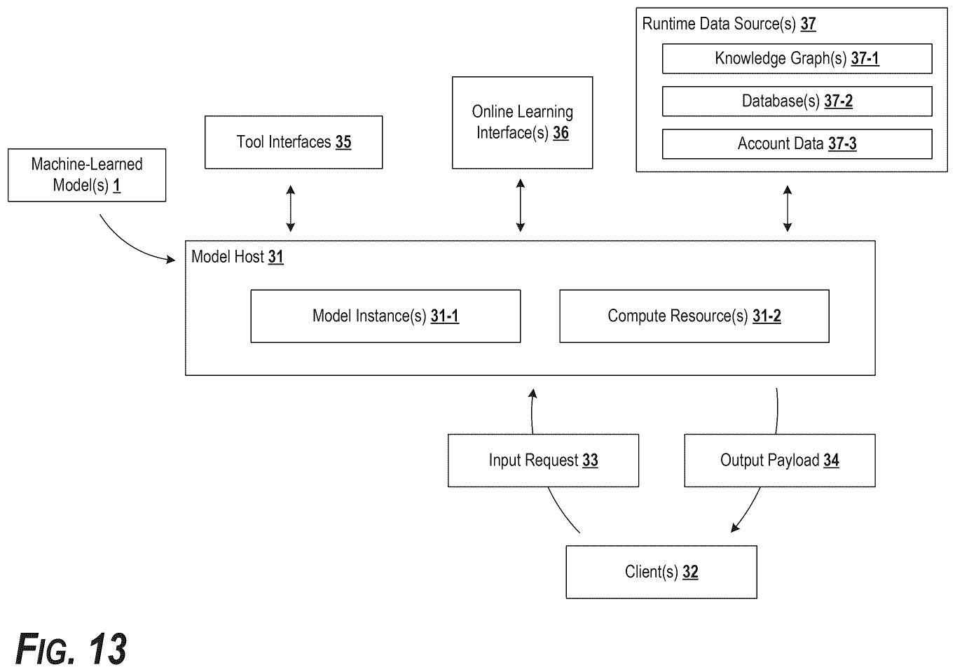

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

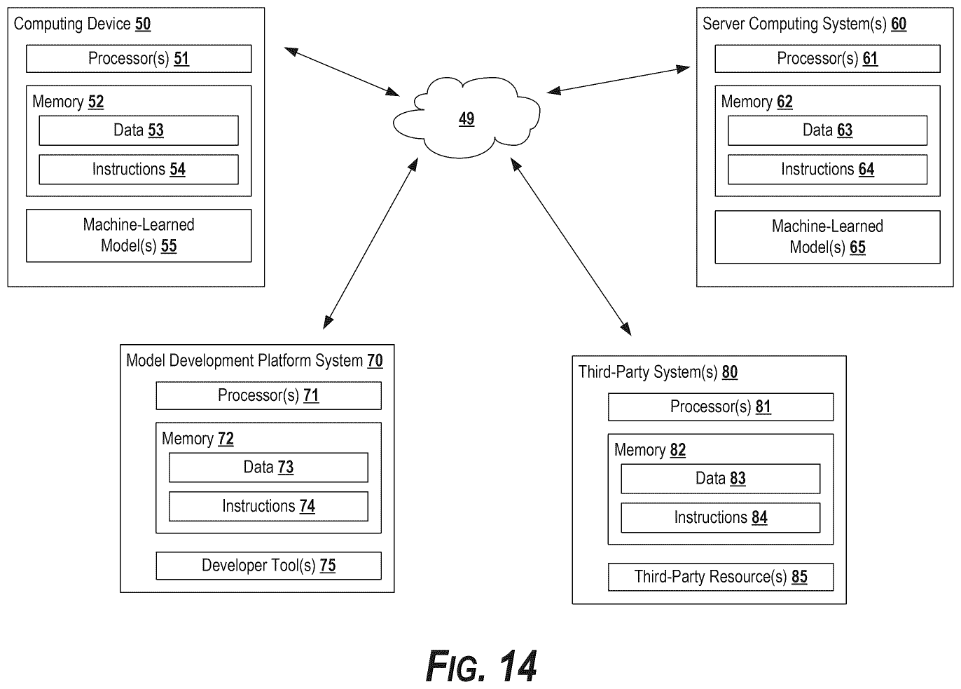

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

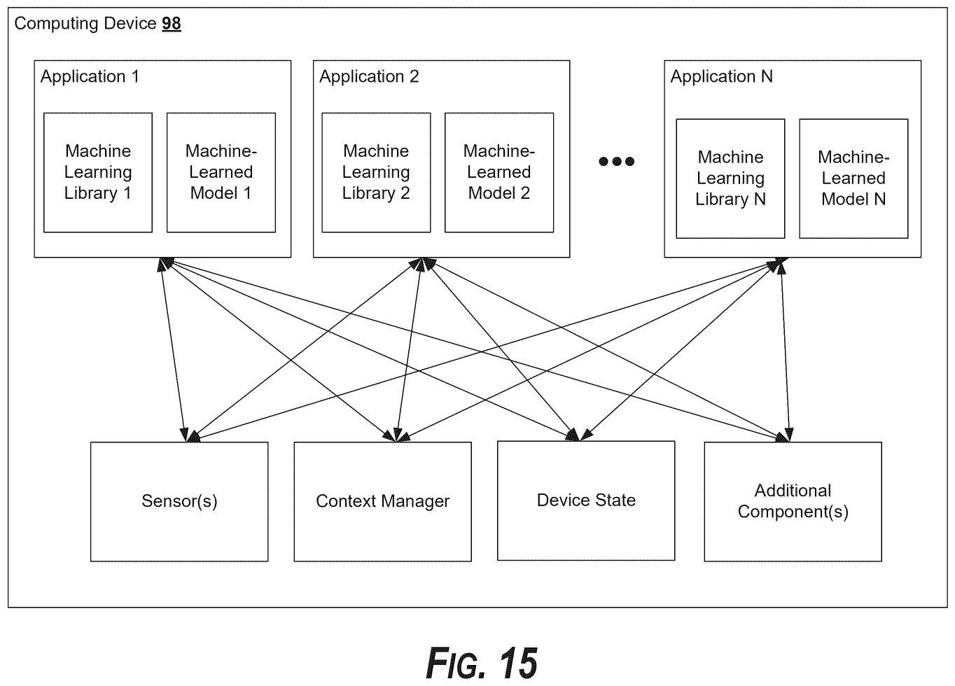

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

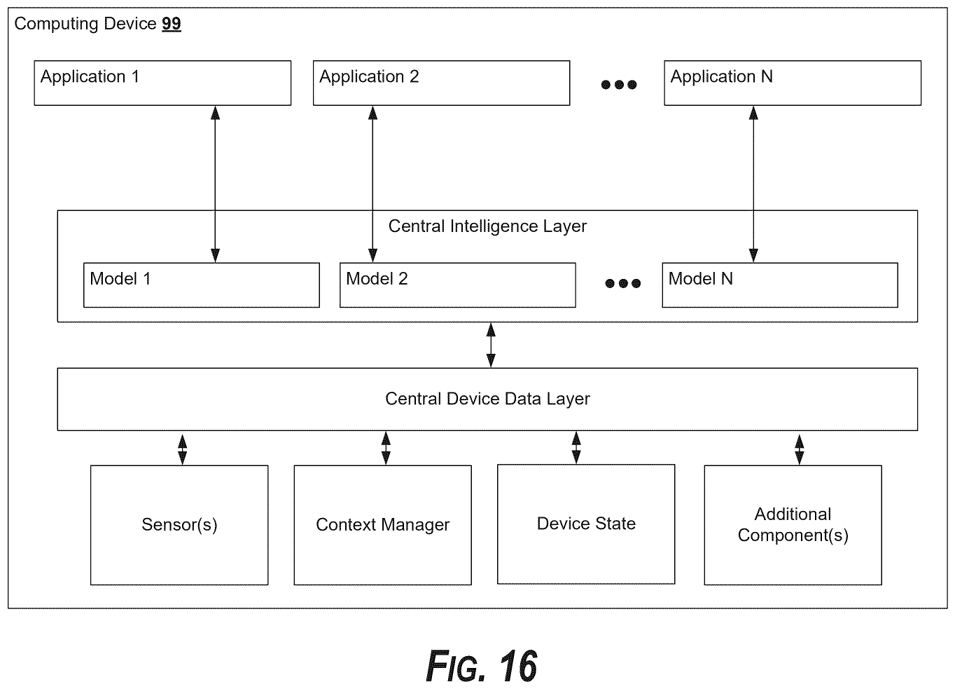

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising, by a computing system including one or more computing devices:
receiving, via a user interface displaying a first set of items, one or more inputs indicative of one or more preferences relative to one or more of the first set of items;
generating, using one or more machine-learned embedding models, one or more preference embeddings in an embedding space for a target content domain based at least in part on the one or more preferences;
comparing the one or more preference embeddings with a plurality of item embeddings in the embedding space;
selecting a second set of content items based at least in part the one or more preference embeddings and the plurality of item embeddings in the embedding space; and
generating data for displaying the second set of content items via the user interface.

2. The computer-implemented method of claim 1, wherein:
the user interface includes a first user interface portion for displaying the first set of items;
the method further comprises:
receiving a user query;
providing the user query as an input to a machine-learned sequence processing model and receiving one or more item retrieval queries;
obtaining a plurality of items based at least in part on the one or more item retrieval queries;
generating data for displaying at least a portion of the plurality of items in a second user interface portion of the user interface; and
selecting the first set of items from the plurality of items for display in the first user interface portion using a preference elicitation system.

3. The computer-implemented method of claim 2, further comprising:
ranking the at least the portion of the plurality of items based at least in part on an output of a preference application system.

4. The computer-implemented method of claim 3, wherein:
ranking the at least the portion of the plurality of items is based at least in part on one or more user embeddings and one or more content embeddings.

5. The computer-implemented method of claim 2, wherein:
the machine-learned sequence processing model is a large language model.

6. The computer-implemented method of claim 2, wherein:
the machine-learned sequence processing model is a multimodal model.

7. The computer-implemented method of claim 1, wherein:
the plurality of items include image data;
the plurality of item embeddings in the embedding space includes a plurality of item image embeddings in the embedding space;
the one or more preference embeddings include one or more preference image embeddings based on the first set of items; and
selecting the second set of items is based at least in part on a distance between the one or more preference image embeddings and the plurality of item image embeddings.

8. The computer-implemented method of claim 1, wherein selecting the second set of content items is based at least in part on a distance between the one or more preference embeddings and the plurality of item embeddings in the embedding space.

9. A computing system, comprising:
one or more processors;
one or more computer-readable storage media that collectively store instructions that, when executed by one or more processors, cause the one or more processors to perform operations, the operations comprising:
receiving, via a user interface displaying a first set of items, one or more inputs indicative of one or more preferences relative to one or more of the first set of items;
generating, using one or more machine-learned embedding models, one or more preference embeddings in an embedding space for a target content domain based at least in part on the one or more preferences;
comparing the one or more preference embeddings with a plurality of item embeddings in the embedding space;
selecting a second set of content items based at least in part on the one or more preference embeddings and the plurality of item embeddings in the embedding space; and
generating data for displaying the second set of content items via the user interface.

10. The computing system of claim 9, wherein:
the user interface includes a first user interface portion for displaying the first set of items;
the operations further comprise:
receiving a user query;
obtaining a plurality of items based at least in part on the user query;
generating data for displaying at least a portion of the plurality of items in a second user interface portion of the user interface; and
selecting the first set of items from the plurality of items for display in the first user interface portion using a preference elicitation system.

11. The computing system of claim 10, wherein the operations further comprise:
ranking at least the portion of the plurality of items based at least in part on an output of a preference application system.

12. The computing system of claim 11, wherein:
ranking at least the portion of the plurality of items is based at least in part on one or more user embeddings and one or more content embeddings.

13. The computing system of claim 10, wherein:
the machine-learned sequence processing model is a large language model.

14. The computing system of claim 10, wherein:
the machine-learned sequence processing model is a multimodal model.

15. The computing system of claim 9, wherein:
the plurality of items include image data;
the plurality of item embeddings in the embedding space includes a plurality of item image embeddings in the embedding space;
the one or more preference embeddings include one or more preference image embeddings based on the first set of items; and
selecting the second set of items is based at least in part on a distance between the one or more preference image embeddings and the plurality of item image embeddings.

16. One or more computer-readable storage media that collectively store instructions that, when executed by one or more processors, cause the one or more processors to perform operations, the operations comprising:
receiving, via a user interface displaying a first set of items, one or more inputs indicative of one or more preferences relative to one or more of the first set of items;
generating, using one or more machine-learned embedding models, one or more preference embeddings in an embedding space for a target content domain based at least in part on the one or more preferences;
comparing the one or more preference embeddings with a plurality of item embeddings in the embedding space;
selecting a second set of content items based at least in part on the one or more preference embeddings and the plurality of item embeddings in the embedding space; and
generating data for displaying the second set of content items via the user interface.

17. The one or more computer-readable storage med510ia of claim 16, wherein:
the user interface includes a first user interface portion for displaying the first set of items;
the operations further comprise:
receiving a user query;
providing the user query as an input to a machine-learned sequence processing model and receiving one or more item retrieval queries;
obtaining a plurality of items based at least in part on the one or more item retrieval queries;
generating data for displaying at least a portion of the plurality of items in a second user interface portion of the user interface; and
selecting the first set of items from the plurality of items for display in the first user interface portion using a preference elicitation system.

18. The one or more computer-readable storage media of claim 16, wherein the operations further comprise:
ranking the at least the portion of the plurality of items based at least in part on an output of a preference application system.

19. The one or more computer-readable storage media of claim 17, wherein:
ranking the at least the portion of the plurality of items is based at least in part on one or more user embeddings and one or more content embeddings.

20. The one or more computer-readable storage media of claim 16, wherein:
the plurality of items include image data;
the plurality of item embeddings in the embedding space includes a plurality of item image embeddings in the embedding space;
the one or more preference embeddings include one or more preference image embeddings based on the first set of items; and
selecting the second set of content items is based at least in part on a distance between the one or more preference image embeddings and the plurality of item image embeddings.
